(19) United States
(12) Patent Application Publication
(10) Pub. No.: US 2004/0152577 A1
(43) Pub. Date: Aug. 5, 2004

(54) Apparatus for making single or multi-size, fold, and color product stacks

(76) Inventor: William P. Niedermeyer, Green Bay, WI (US)

Correspondence Address: William P. Nledermeyer, 1024 Mt. Mary Drive, Green Bay, WI, 54311, US

(21) Appl. No.: 10/356,938

(22) Filed: Feb. 3, 2003

(51) Int. Cl. B31F 1/10

(52) U.S. Cl. 493/428

(57) ABSTRACT

Apparatus for producing selected color or material sequences within a stack of transversely single or doublefolded products. Product width webs are longitudinaly folded and slideably advanced at slow speed metering rolls to create alternate void spaces before a segment is cut so that unocuppied alternate repeats on each anvil roll of the plurality can accept folded segments from other units in the plurality. With programmable changes to the same plurality of cutoff units including changes in the amount of web slippage before cutoff, several smaller product segments are cut, cooperatively folded and advanced by anvil and carrier rolls to produce different sizes within the color sequence defined by machine configuration. In another embodiment, programmable commands for selection of vacuum path, phase change of fold line, speed change to web metering roll and synchronized speed control during production vary the amount of web slippage, the resultant segment size, and folded product size within a single color stack.

### FIELD OF THE INVENTION

This invention involves vacuum folding apparatus to make single or double transverse folds in articles like napkins from one, two, or more, different colored webs and delivering them as color or material mixed stacks.

Other embodiments include means for making multiple sizes for single or double vacuum cross folds in single or two color stacks.

### BACKGROUND AND SUMMARY OF THE INVENTION

Co-invented U.S. Pat. No. 6,375,605 B 1 describes apparatus for combining spaced segments from each of two or more tandem mounted cutoff units to form a continuous intermixed stream of differently colored segments that are subsequently folded by air blast, etc.

By using slow speed metering rolls in U.S. Pat. No. 6,375,605 B 1, each incoming web is slidably advanced to alternate repeat surfaces of an anvil roll before cutting. One cutoff unit feeds spaced segments to even repeats, a second cutoff unit feeds spaced segments to odd repeats. The two streams of spaced segments are transferred to, and combined on a carrier for subsequent air folding as a continuos series of intermixed colors or materials for subsequent packout and delivery into stacks.

In the instant invention, segments are vacuum held against the anvil roll and advanced until vacuum is applied to carrier ports along a pre-selected fold line.

This extended timing of anvil roll vcuum results in the fold being made by interaction between the anvil and carrier roll vacuum before and as it is transferred to the carrier surface.

Apparatus for vacuum folding is described in prior art teachings U.S. Pat. No. 3,689,061 of Nyatrand, U.S. Pat. No. 3,870,292 of Bradley, and U.S. Pat. No. 4,329,185 of Small, all of which produce single color stacks of one size.

The instant invention utilizes the same slow speed infeed and cutoff and further describes details for vacuum ports arrangements and timing needed to produce color mixed stacks, but also the use of slow speed feed rolls in combination with multiple ports on multiple fold lines to produce products of various sizes for single or multiple color stacks.

It is an object of this invention to describe means to complete an overfold using vacuum in anvil and carrier roll ports rather than air blast and a stationary plate.

Another object is to define folding apparatus using various combinations of vacuum port placement and timing to describe apparatus for multiple sizes, including independent drives for selected components and changes in phase relationships between anvil and carrier rolls as a function of product size.

These and other advantages and objects of the invention may be seen in the ensuing specifications:

### BRIEF DESCRIPTION OF THE DRAWINGS

FIG. 1 is a side elevation schematic illustrating a prior art single napkin folder for packout of napkins from a series of napkins to produce a one color stack.

FIG. 2 is a side elevation schematic illustrating a prior art doublefold napkin folder for packout of napkins from a series of napkins to produce a one color stack.

FIG. 3 is a side elevation schematic of the inventive folder illustrating placement and timing of two cutoff units to produce a stream of single folded napkins with alternating colors or materials for packout into stacks.

FIG. 4 is an enlarged side elevation of the anvil/knife roll pair illustrating typical components to control and cut segments from a web.

FIG. 5 is an enlarged side elevation of the two cutoff units in FIG. 3 illustratnig phase relationships and folding cooperation between the anvil and carrier rolls.

FIGS. 6A through FIG. 6H are side elevation schematics illustrating advancement of segments at anvil surface speed and slipping advancement of the incoming web to create an open repeat surface on the anvil roll in order to receive alternate segments from the second cutoff unit.

FIG. 7A and FIG. 7B are plan view schematic diagram illustrating vacuum timing, force, and duration to achieve advancement and slipping advancement of segments (shown unfolded) along a path from each of two cutoff units.

FIG. 7C is a plan view schematic illustrating placement of the combined folded segments on the carrier surface to produce a stream of alternately colored napkins.

FIG. 8 is a side elevation schematic illustrating placement of three cutoff units mounted in tandem along a common carrier roll path.

FIG. 9 is a side elevation schematic illustrating location of two cutoff units along a common carrier roll path, each including a first anvil/folding roll and second folding roll coacting with a carrier to produce a two color stack of doublefolded products.

FIG. 10 is a plan view schematic of one repeat surface of the carrier roll arranged with air apertures to complete a second cross fold on a consecutive series of single folded segments.

FIG. 11 is a front elevation view schematic of longitudinal folding plates viewed along line 11-11 of FIG. 3 illustrating the arrangement of folding plates, draw rolls, and turning bars for a plurality of product webs from a multi-width web.

FIG. 12 is a top view schematic viewed from line 12-12 of FIG. 11 illustrating one of two full width webs being slit into a plurality of product width webs and advanced over V-fold plates into the nip of pull rolls before advancement over turning bars and subsequent slow speed draw rolls.

FIG. 13 is a plan view schematic viewed from line 13-13 of FIG. 11 illustrating superposed product webs being separated and turned 90 degrees for advancement to the slow speed and cutoff section.

FIG. 14 is a a simplified side elevation schematic of FIG. 8 illustrating the three color being advanced for packout.

FIG. 15 is a simplified side elevation schematic illustrating two folders of FIG. 8 arranged face-to-face and the resultant color sequence produced for packout.

FIG. 16 is a side elevation schematic view of an anvil roll illustrating means for selecting a vacuum conduit for a selected product length.

FIG. 17A is a plan view schematic of anvil repeat surfaces illustrating vacuum port arrangment for a segment length equal to a repeat surface.

FIG. 17B is a plan view schematic of anvil repeat surfaces on a second unit illustrating vacuum port arrangement for a segment length equal to about ⅔ of a repeat surface.

FIG. 17C is a plan view schematic of anvil roll repeat surfaces illustrating vacuum port arrangement for a segment length equal to about ½ of a repeat surface.

FIGS. 18A-18C are simplified side elevation schematics of the FIG. 3 apparatus illustrating changes in phase relationships between anvil and carrier for three different segment sizes.

FIG. 18A is a side elevation schematic illustrating roll phase relationships for a product length that equals length of a repeat surface.

FIG. 18B is a side elevation schematic illustrating phase relationships for a product length equal to about ⅔ of a repeat surface.

FIG. 18C is a side elevation schematic illustrating phase relationships for a product length equal to about ½ of a repeat surface.

FIG. 19 is a simplified side elevation schematic illustrating apparatus with only one cutoff unit and separate stepping motor drives for phase change between anvil—carrier, selected slow speed for metering roll and synchronous roll rotation.

FIG. 20A is a plan view schematic illustrating vacuum ports along the leading margin for three different segment lengths on an anvil surface.

FIG. 20B is a plan view schematic illustrating vacuum ports arranged along fold lines for three different segment lengths on a carrier surface.

FIG. 20C is a side elevation schematic illustrating two longest segments L 1 folded, placed. and advancing on 2 consecutive carrier repeats.

FIG. 20D is a side elevation schematic illustrating two folded segments L 2 folded, placed and advancing on 2 consecutive carrier repeats.

FIG. 20E is a side elevation schematic illustrating two folded segments L 3 folded, placed and advancing on 2 consecutive carrier repeats.

### DETAILED DESCRIPTION OF THE INVENTION

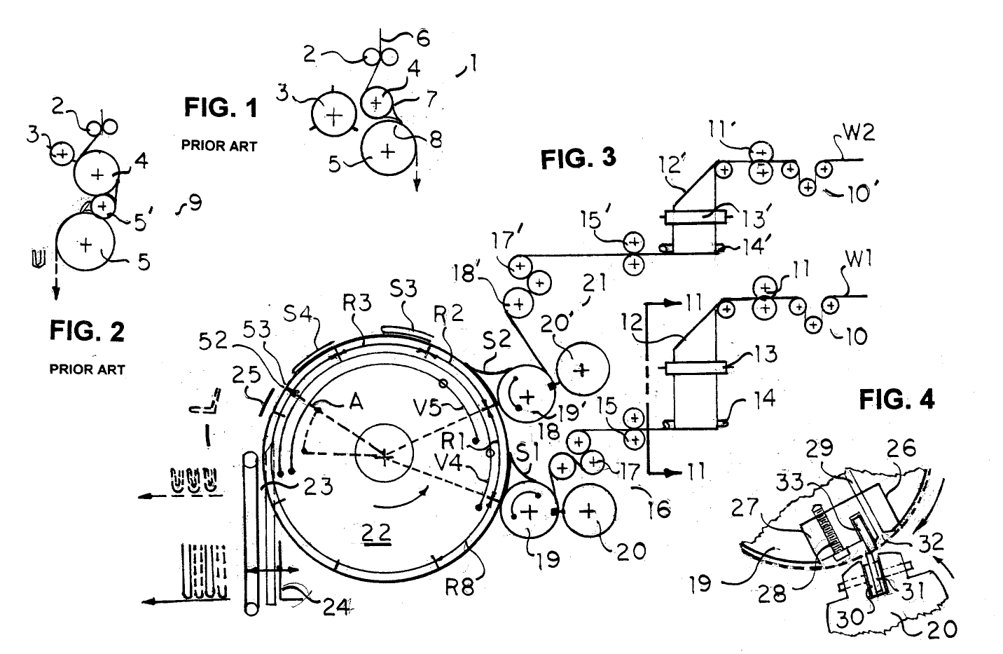

In prior art folders of FIGS. 1-2, rolls having the same function have the same reference numbers.

In FIG. 1, vacuum folding apparatus 1 produces a singlefolded product and is comprised of draw rolls 2, knife roll 3, anvil roll 4, and carrier 5.

In FIG. 1, longitudinally folded web 6 (folding plates not shown) is advanced by draw rolls 2 and held on the surface of anvil roll 4 by vacuum ports that communicate with conduits drilled into the solid roll blank parallel to the axis of rotation.

After a segment is cut by knife roll 3, anvil roll 4 grips the leading edge of the front half panel until it reaches release position 7. Similar vacuum ports in carrier 5 located midway between segment ends 8 advance the trailing portion until the lead panel portion is released from anvil roll 4 to complete the fold.

In folding apparatus 9 of FIG. 2, a first transverse fold is completed by folding co-action between anvil roll 4 and a subdequent vacuumized roll 5′.

In FIG. 2, roll 5′ includes a transverse line of vacuum ports along a second fold line FD-FD′ (see FIG. 10) between first fold line FS-FS′ and the cut end 8′ of a segment S to create a double cross folded product like a dinner napkin by second folding co-action between rolls 5′ and roll 5.

In FIG. 3, cutoff units 16 and 21 are spaced one repeat R apart along the periphery of the carrier 22. Cutoff units can be spaced differently and the anvil/carrier roll phasing of each advanced or retarded as required.

In FIG. 3, lower cutoff unit 16 and related components are described below. Upper cutoff unit 21 operates the same and similar elements have the same reference numbers with a prime mark (′).

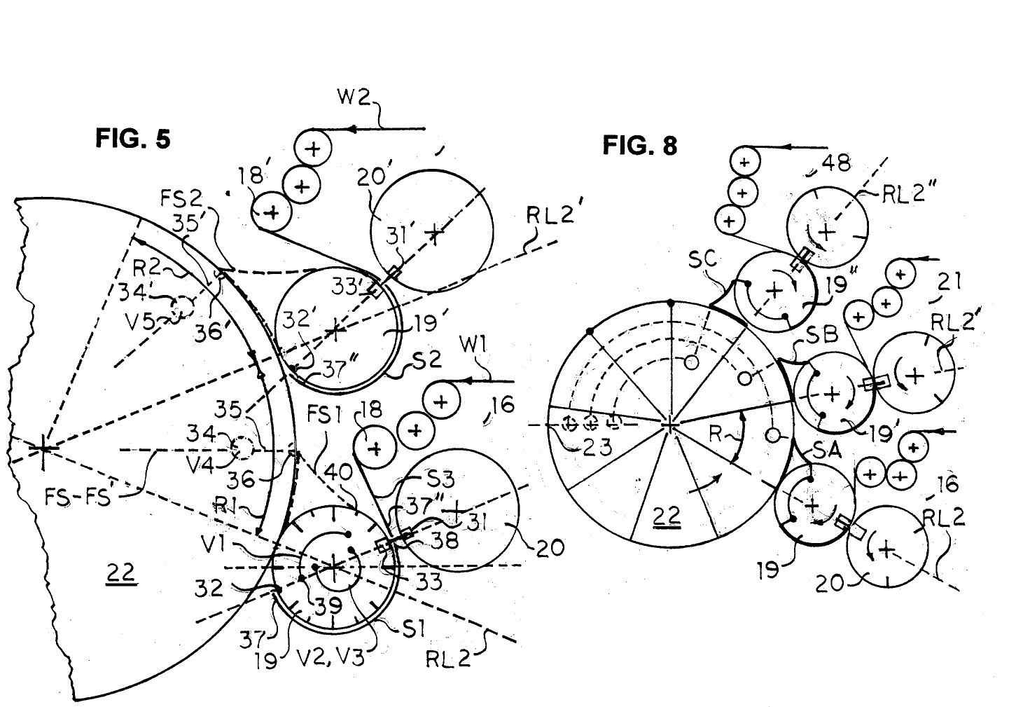

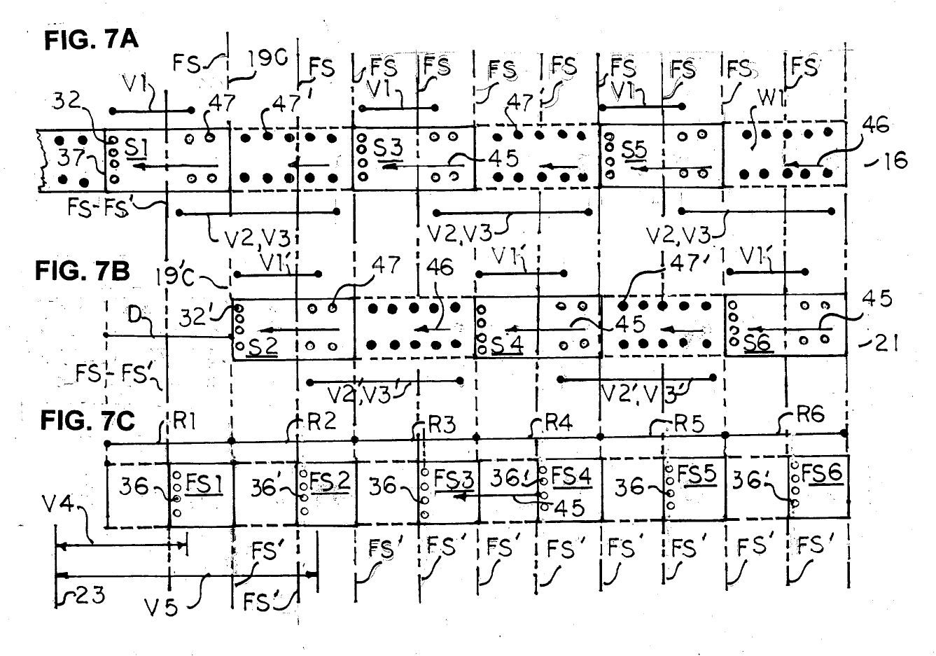

In FIG. 3, cutoff unit 16 creates a series of spaced apart segments S 1, S 3, S 5, etc. (see FIG. 7A), for cooperative folding with anvil vacuum V 1 (see FIGS. 5,7) and carrier vacuum V 4 for transfer to spaced carrier roll repeats R 1, R 3, R 5, etc., and for subsequent combining with folded segments from a second unit 21.

Surface speed of anvil rolls 19 and carrier 22 are the same carrier.

In FIG. 3, cutoff unit 21 simultaneously processes web W 2 into a series if spaced segments S 2, S 4, S 6, etc. (see FIG. 7B) held on alternate repeats of the anvil for cooperative folding with anvil vacuum V 1′ and carrier V5, and transfer to spaced unoccupied repeat surfaces R 2, R 4, R 6, etc. on the carrier to create a series of segments S1, S 2, S 3, S 4, etc on consecutive repeats of the carrier (see FIG. 7C) and advancment to removal position 23 and packout by reciprocating fingers 24.

Prior to the above functions in FIG. 3, web W 1 advances through constant tension device 10, and slitters 11 to slit a full width web into two or more product webs (slitting not required for 1-wide parent rolls), over longitudinal folding plate 12, through pull rolls 13, over turning bar 14, through draw roll5 15, S-wrap roll 17, and over variable speed metering roll 18 at a pre-selected speed less than anvil roll surface speed.

Details for each cutoff unit 16, 21 are similar and FIGS. 5, 6, 7 below describe slow speed web feed by metering rolls 18, 18′ relative to slippage and advancement to create the above-mentioned space between consecutive segments on each anvil roll.

One embodiment for a second fold involves air blast through apertures 53 in the carrier surface (see FIG. 10) to lift the front portion of the already folded product, and stationary plate 25 creates the second cross foldover (see also FIG. 9 for another doublefold embodiment).

In FIG. 4, machined slot 26 contains anvil holder 27 fastented by bolt 28 to roll 19. Vacuum passages 29 communicates with vacuum conduits drilled parallel with the axis of rotation. Vacuum is applied from circular grooves in a stationary valve communicating with a vacuum source (both known means not shown).

In FIG. 4, co-acting knife roll 20 includes an adjustable knife holder 30 containing knife 31. Ports 32 adjacent anvil 33 normally hold the web taut during cutoff.

In well known practice, vacuum to grip the leading edge of a segment is applied before the cut. The gripping vacuum applies tension to the web from the cut edge to the incoming web portion approaching the cutting position. Other means to hold the web at cutoff can include instantaneous vacuum on the web when cut (on-off of ports 32), or smaller and fewer ports adjacent the anvil since the web must slip immediately after the cut.

In FIG. 5, a lower 2-time anvil roll 19 having one anvil 33 contacts the surface of carrier 22 at radial line RL2 and is arranged one repeat distance R 1 apart from second anvil roll 19′.

Both cutoff systems 16, 21 are the same. For brevity, function of only the first unit is described noting that folded segments FS1 from cutoff unit 16 and FS2 from unit 21 (both shown dashed) are placed on consecutive repeats R1, R 2′ of the carrier surface as described above.

In FIG. 5, anvil 33 underlies a cut common to the trailing edge 38 of a cut segment and the leading edge 37″ of the incoming slow speed web.

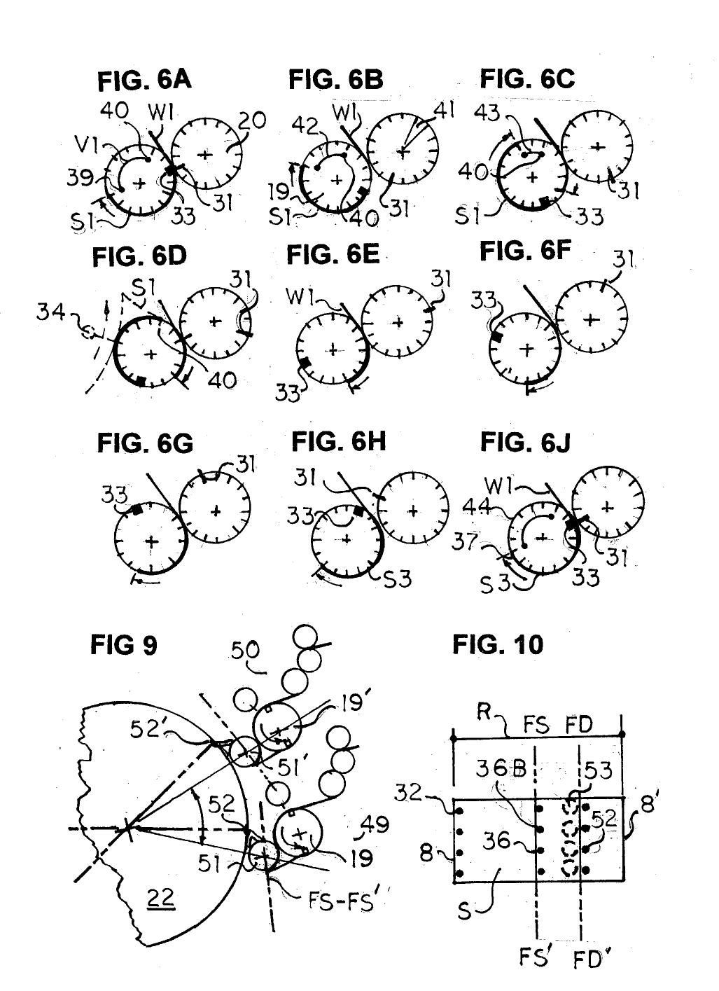

In FIG. 5, the leading edge of segment S 3 is cut on the same line as the trailing edge 38 of segment S 1. In FIGS. 6A to 6H, segment S 3 is progressively slipped over one repeat surface of the anvil roll to create a blank space between S 1, S 3. etc.

In FIGS. 5, 6A-6J, the anvil roll is marked in 22 ½ degree segments as a common reference for anvil roll rotation versus the lead edge of the next to be cut segment, noting that the knife/anvil rolls make one cut each revolution of 24″ versus 12″ web feed during the same time.

In a typical example, the surface speed of the anvil roll is 450 fpm for transferring folded 12″ segments to the carrier (also at 450 fpm), while the webs from each cutoff unit are advancing at 225 fpm and combined to deliver 450 products/min to the carrier roll.

For larger repeat lengths and larger roll diameters requiring more space than 1 repeat between two successive cutoff units, phasing of anvils relative to carrier roll fold lines change along with timing of carrier folding vacuum.

In FIG. 5, the leading edge 37 of segment S 1 is gripped by vacuum V 1 in ports 32 at position 39 and advanced to position 40 where the lead panel is overfolded, vacuum V 1 stops, and the folded segment FS1 is transferred to the carrier 22 by vacuum in ports 36.

In FIG. 6A (like FIG. 5), anvil 33 and knife 31 cut web W land at the same time as vacuum V 1 is applied at position 39 to advance the leading edge of the first cut degment S 1 to position 40.

Carrier 22 (not shown) coacts with roll 19 to complete he fold by applying vacuum V 4 to ports 36 (dashed) at the mid-point fold line FS-FS′ of segment S 1 (see FIG. 10).

In FIG. 6B, cut segment S 1 advances two 22 ½ degree arcuate portions whille web W 1 advances one portion at half speed. Vacuum V 1 in path 42 grips and advances the segment.

In FIG. 6C, similar S 1 and W 1 advances occur. Reduced vacuum path 43 terminates at 40 when the leading edge of S 1 is ready to be overfolded as shown dashed in FIG. 6D.

Upon further anvil rotation in FIGS. 6E through 6H, the slow speed web is slideably advanced until reaching the position shown as S 3.

In FIG. 6J, the absence of a segment on 180 degrees of anvil surface 44 results in a blank space on alternate repeats of the carrier roll 22. FIGS. 6J, 8A, and FIG. 5 are similar and comparable.

In FIG. 5, similar means and operation place folded segments S 2, S 4, etc. from cutoff unit 21 on the alternate blank repeats of the carrier.

In FIG. 7A, segment S 1 on lower roll 19 (See FIGS. 3, 5) is severed from web W 1 at cut line 19C

In FIG. 7A (left side), vacuum ports 32 under leading edge 37 of segment S 1 grip and advance it to position 40 of the anvil roll without slippage (see FIGS. 5, 6C)

In FIG. 7A, ports 47′ under web W 1 apply restricted vacuum to allow slipping advancement. In one anvil roll revolution, the web slips 180 degrees to be deposited as S 3 when the next cut occurs.

In FIG. 7A, the same slipping advancement occurs to cut another segment shown as S 5. Vector 45 represents full speed advancement of S 1. Vector 46 represents resultant half speed of the sliding web.

In FIGS. 7A and 7B, vacuum V 1 is applied to ports 32′ on the lead edge 37, 37′ of segment S 1, S 2 respectively. V 2 restricted vacuum is applied to ports 47 (circles) which grip a cut segment S and V 3 (solid) to allow slippage of the uncut slow speed web as described.

In FIG. 7B, space D is segment displacement due to a repeat space between the carrier contact point with two spaced cutoff units 16, 21.

In FIG. 7B, segments S 2, S 4, S 6, etc are cut, slipped, and advanced by the upper cutoff unit 21.

In FIG. 7C, both streams of spaced folded segments are combined to form a consecutive series of products advancing on the carrier at speed vector 45.

In FIG. 7C, full vacuum V 4 (shown in FIG. 3) is applied to carrier ports for segments S1, S3, S5, etc and full vacuum V 5 (see FIG. 3) is applied to carrier ports for S 2, S 4, etc.

In each instance, vacuum starts just before the carrier reaches the midpoint segment fold line FS-FS′. (see FIG. 10).

In FIG. 8, three cutoff units 16, 21, and 48 are arranged one repeat R apart on the periphery of carrier 22 to advance, cut, fold and transfer segments S A, S B, S C etc, to consecutive repeat surfaces of the carrier for packout in the same sequence at position 23.

The apparatus of FIG. 8 produces a 3-color (or 3 different materials) sequence from 3 webs each advancing at ⅓ the surface speed of the anvil 19 and carrier 22 rolls, etc.

In FIG. 8, each of three webs run at a speed equal to one-third of the carrier surface, and with one web stopped, each web in a two color sequence runs at ½ carrier surface speed.

In FIG. 9 double folding apparatus, each cutoff unit 49, 50, includes a second folding roll 51 to make the second fold.

In FIG. 9, roll 51 grips the leading folded edge, and in cooperation with carrier ports 52, completes a second cross fold on line FD-FD′ for advancement on spaced repeat surfaces of the carrier.

In FIG. 9, roll 51′ of upper cutoff unit 50 coacts with ports 52′ on carrier 22 to fold and deposit doublefolded segments on alternate blank repeat surfaces left blank by first unit 49.

In FIG. 10 when making a single fold product (as in FIGS. 3, 5, 6, 7), ports 32 on leading edge 8 of segment S advance with anvil roll 19 until ports 36 in carrier roll grip the segment along FS-FS′ to complete the first fold.

In FIG. 10 when making a doublefold, ports 36B (same location as 36, but on second roll 51) complete the first fold and ports 52 on the carrier roll 22 complete the second fold along line FD-FD′.

Referring back to FIGS. 3, another embodiment for double folding involves two cutoff units (each with one anvil/folding roll) that complete the first fold with vacuumized anvil ports 32 and carrier ports 36 for the first fold along FS-FS′ (see FIG. 10), and air blast A through carrier apertures 53 (see FIG. 10) to uplift the leading portion and complete the second fold along line FD-FD′ with a stationary plate (see 52, 53, and 25 on left side of FIG. 3).

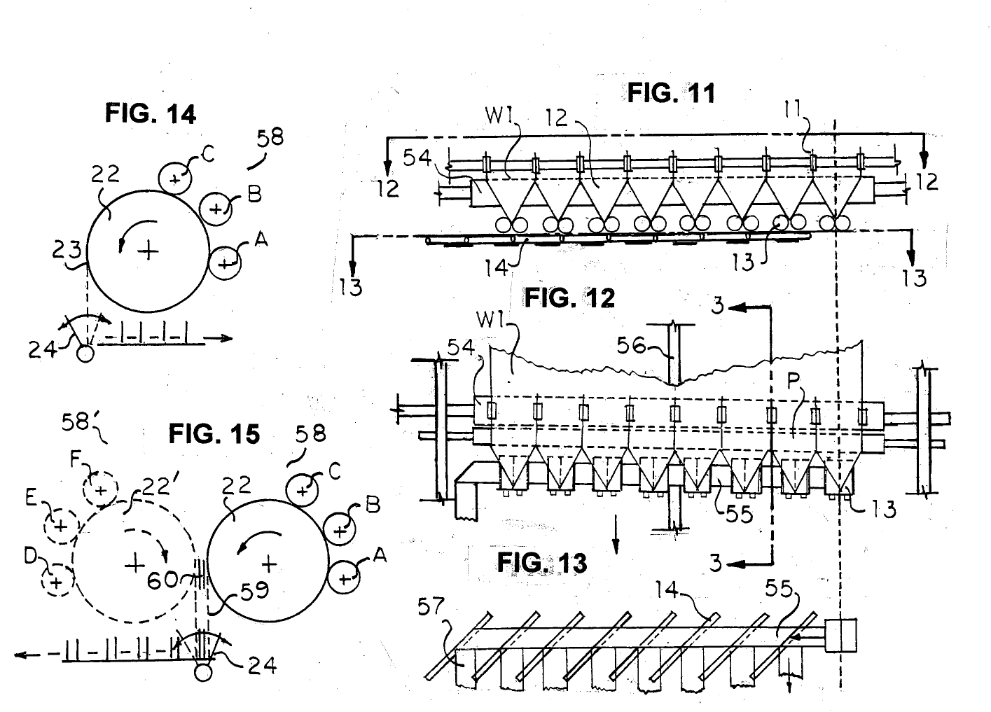

In FIG. 11, incoming web W 1 is supported by slitter bedroll 54 as it is slit into a plurality of product width webs P. For single width parent rolls slitters 11 are not required.

With one or more producrt width webs P, each web is drawn over folding plates 12 by draw rolls 13, threaded around turning bars 14 and pulled toward web metering rolls 18 by pull rolls 15. (see right side of FIG. 3). In lieu of turning bars, parent rolls can be fed from the side.

In FIG. 12, after individual webbs P are longitudinally folded by plates 12, they are superposed for a short distance (as at 55) before each web is turned 90 degrees as at 57 for entry into the metering and cutoff units 16, 21, etc.

.FIG. 13 turning bars 14, superposed webs 55 and individual webs 57 are shown in plan view for clarity.

FIG. 14 (like FIG. 8 above) is a complete (single) folding apparatus that includes three cutoff units referenced a for W 1, b for W 2 and c for W 3 to produce a color sequence. If three webs are used, unit a will deposit the first folded segment a (see Sa in FIG. 8) and in turn, b, then c, to define a series of sequences A-B-C . . . A-B-C . . . etc.

In FIG. 15, two duplicate folding apparatus are arranged face-to-face to deliver superposed folded segments 60 between delivery belt pair 59 for packout by reciprocating packers 24 to define a series of sequences CF-BE-AD . . . CF-BF-AD . . . etc.

Generally, the arrangement of FIG. 14 (1-4 wide webs) is used to produce coin edge embossed napkins from 2 or 3 ply stock, while the arrangement of FIG. 15 would use multiple width parent rolls of 1-ply stock for commercial or consumer napkin products.

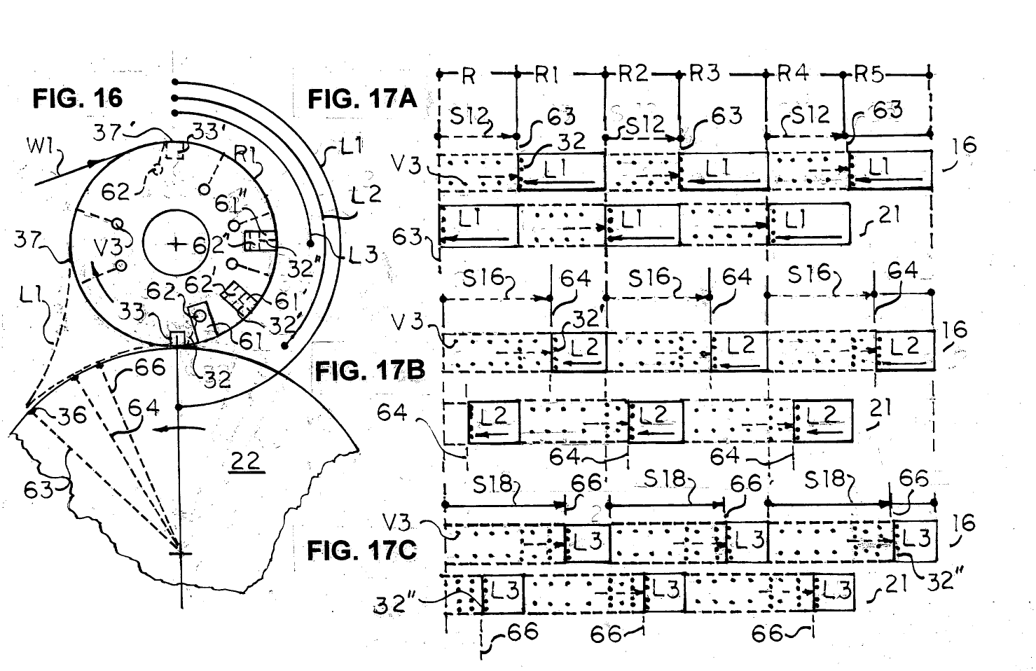

In FIG. 16 cross section adjacent an end of roll 19, bored holes (not referenced for clarity) each contain rotatable inserts 61, 61′, 61″ with passage holes 62, 62′, 62″.

Hole 62 is shown open for vacuum V 1 to communicate with a matching conduit drilled transversely in the roll body. Drilled holes (shown dashed) connect vacuum in the conduits to ports 32. 32′, 32″ on the surface of roll 19.

Insert 61 is shown activated for product L 1 while inserts 61′, 61″ are turned 90 degrees and are inactive.

One selected insert is rotated to activate a selected conduit and line of vacuum ports while others are turned off. Electronic valve means can be used for programmable activation or shutoff.

In FIG. 16, roll 19 has one anvil 33. The incoming web W 1 advances at a selected speed to make the anvil/knife cut at position 33′ (shown phantom) when the proper length L 1, L 2 etc. is fed beyond cutting position at 33′.

In FIG. 16, vacuum V 1 on leading edge 37 of segment L 1 (see left side of anvil roll) ends when fold line FS-FS′ reaches line 63 (zero reference line) when product length equals repeat length.

For shorter lengths L 2, L3, folded length and fold lines change, and retarding carrier 22 compensates to keep the segment trailing edge at the nip between anvil and carrier rolls

Means and steps to change sizes are detailed below.

In FIGS. 16,17, segment lengths L 1, L 2, L 3, are generated on the surface of anvil roll 19 and in this instance product lengths of 12″, 8″, and 6″ are described as a typical example.

In FIG. 17A, slippage of 12″ (S12) is required to keep every other repeat open for segments L 1′ from another unit—as in FIG. 5.

In FIG. 17A, leading edge 37 of W 1 advances at slow speed toward position 33 during one anvil roll revolution of 2 repeat surfaces. Slippage S 12 represents retarding the lead edge (of web L1) 12″ until it reaches the position of anvil 33 (shown solid) and thereafter is cut and folded by coaction of anvil and ports 36 on the carrier roll.

In FIG. 17B for shorter product L 2 (8″), the amount of web slip S 16 on the anvil roll is one repeat plus 4″ with the phase angle correction made by retarding the carrier to fold line position 64.

In FIG. 17C, for product L 3 (6″ length), the amount of web slip (S 18) is one repeat plus 6″, with phase correction made by retarding the carrier to fold line position 66.

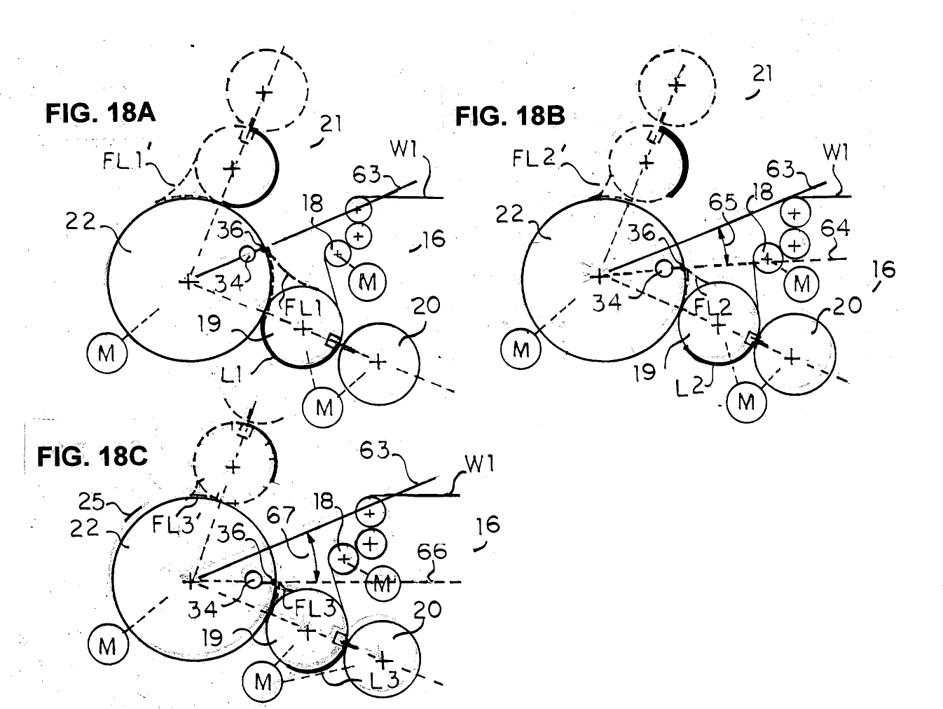

In FIG. 18A, carrier ports 36 on fold line 63 (base reference) is in phase for L1.

In FIG. 18B, due to shorter folded length 2, the fold line is retarded by rotating carrier 22 to position 64 by retarding the carrier an amount shown as 65.

In FIG. 18C, shorter product L3 and shorter folded length FL 3 require rotation of carrier 22 to fold line 66 by retarding it an amount shown as 67.

In FIGS. 18A-18C, separate, digitally controlled variable speed programmable stepping motors M rotate metering roll 18 for a pre-determined web speed and drive the anvil/knife roll pair in synchronous surface speed with the carrier, after the steps of; selection of the active anvil roll vacuum conduit 61, 61′ etc., phasing of carrier fold line to the anvil roll, adjust for proper web speed required by L1. L2, etc and energizing drives to maintain the set relationships in synchronism.

In the apparatus of FIGS. 3 to 15 with one or two curoff units, web feed speeds of ½ or ⅓ of the anvil surface speed are required to slip the incoming web to create blank repeat space (s) for full length segments from other units.

Apparatus described in FIGS. 16-18 are also capable of making a range of product sizes in a color mixed sequence and require ½ web speed times the ratio of segment sengths. For example, ½×8″/12″ or 0.333 of anvil surface speed.

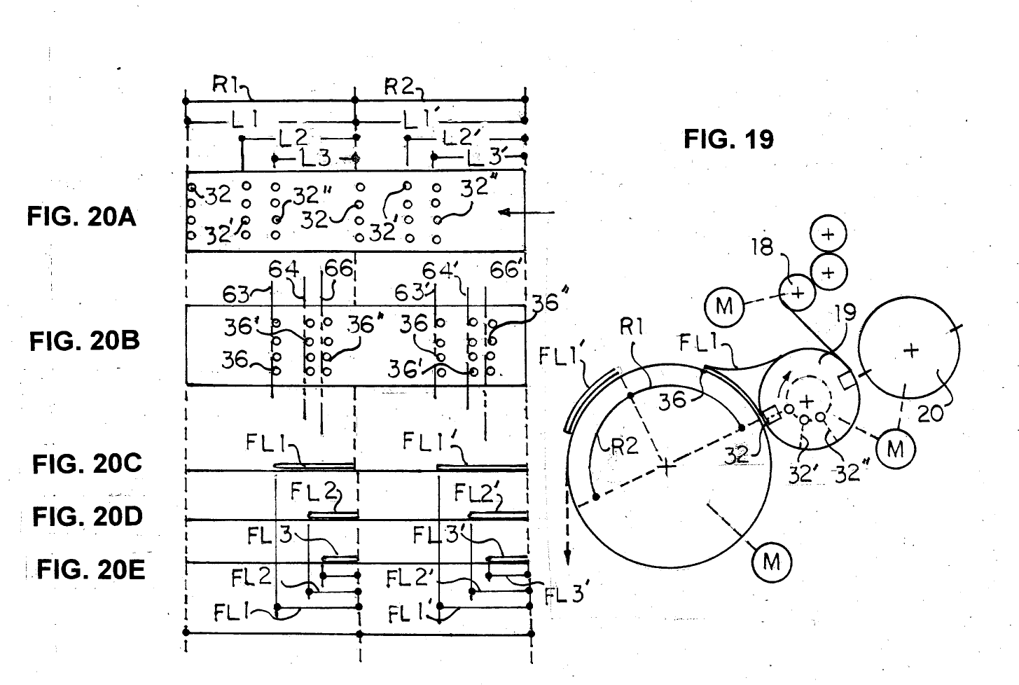

FIGS. 19 and 20 describe the use of only one of the described cutoff units for a range of sizes in only one color.

In the embodiment of FIG. 19, similar elements including drives, cutoff and carrier components etc., are located and operated in similar manner using a 2-time anvil roll and 2-time knife roll to cut and advance a segment on each consecutive repeat surface for folding transfer to the carrier.

In FIG. 19, segments FL1, FL1′ advance on consecutive repeat surfaces R 1, R 2 respectively and web speed is increased equal to anvil and carrier roll surface speed times the ratio of product size.

Apparatus in the embodiment of FIG. 19 produces multiple sizes without intermediate blank repeat spaces at pre-selected uniform web speed for slippage of shorter products. For example, for the 3 sizes compared above, zero slip for 12″, 4″ slippage for L2, and 6″ slippage for L3 using the approporate web speeds.

In FIG. 20A, anvil roll ports 32, 32′, 32″ are positioned for the leading edge of three product lengths for two consecutive repeat surfaces R 1, R 2. etc.

In FIG. 20B, carrier fold line ports 36.36′ etc. are positioned along fold lines 63, 64, 66 for products L1, L2, L3 respectively.

In FIG. 20C, folded segments SF1, FS1′ are deposted on repeats R 1, R2, respectively to result in folded lengths FL 1, Fl 2, FL 3.

In FIGS. 20C-20E, folded lenght is ½ of segment length, but can be changed to other ratios.

It is furthermore to be understood that the present invention may be embodied in other specific forms without departing from the spirit or special attributes, and it is therefore desired that the present embodiments be considered in all respects as illustrative, and therefore not restrictive, reference being made to the claims rather than the foregoing description to indicate the scope of the invention.

Having thus described the invention, what is desired to protect by Letters Patent are the following claims:

### Reference Numbers

FIG Ref No Description

1 singlefold apparatus

2 draw rolls

3 knife roll

4 anvil roll

5 carrier roll

6 longitudinally folded web

7 release position of leading edge from anvil roll

8 vacuum ports at miidway folding position

9 doublefold apparatus

5′ doublefold vacuum folding roll

W1 bottom first web

W2 top second web

10 3-roll constant tnesion system

11 product width web slitter

12 plates for longitudinal fold

13 pull rolls

14 turning bars

15 pull rolls

16 first web cutoff unit

17 s-wrap roll pair

18 variable speed metering roll

19 anvil roll

20 knife roil

21 second web cutoff unit

22 carrier roll (or cyllinder)

23 product removal position

24 reciprocating packer fingers

25 stationary plate to complete a doublefold (air blast apertures not shown in carrier)

R1 first repeat surface on carrier

R2 . . . subsequent repeat surfaces on carrier

S1 . . . folded segments S 1, S 3, S 5 from cutoff 16

V4 vacuum for fold line ports on segments from 16 (unit 19)

S2′ . . . folded segment S 2, S 4, S 6, from cutoff 21

V5 vacuum for fold line ports on segments from cutoff 21

26 machined slot for anvil holder

27 anvil holder in roll 19

28 bolt for holder

29 vacuum passage in anvil

30 knife holder in roll 20

31 knife blade

FS1 first segment from cutoff unit 16

FS2 first segment from c.o. unit 21

S3 slow speed web for next spaced segment

33 anvil in roll 19

34 vacuum conduit in carrier 22

35 vacuum channel to carrier ports 36

36 carrier vacuum ports

37 leading edge of first segment

37′ leading cut edge of incoming web

38 trailing edge of segment

39 leading margin when anvil vacuum V I starts

40 leading margin when anvil vacuum V 1 stops

V1 anvil roll vacuum applied to lead edge 37

V2 anvil roll restricted vacuum (circle) (no slip)

V3 anvil roll restricted vacuum (solid)-web slippage

RL2 carrier radial line of contact w/anvil roll

V5 anvil roll vacuum applied to lead edge 37″

41 22 ½ degree arcuate portion of rotation

42 vacuum path in FIG. 6b

43 vacuum path in FIG. 6c

44 blank repeat (no segment)

45 full speed forward vector

46 resultant half speed forward vector

47 restricted vacuum carrier ports for gripping

47′ restricted vac. carrier ports for slip(ping advancement

D spacing on carrier between cutoff units

19C cut line, lower cutoff unit

19′C cut line, upper c.o. unit

48 third cutoff unit

S A segment from #1 cutoff

S B segment from # 2 cutoff

S C segment from # 3 cutoff

49 lower double fold cutoff unit

50 upper double fold cutoff unit

51 second fold roll-lower unit

51′ second fold roll-upper unit

52 vacuum ports for doublefold line FD-FD′

53 air blast apertures

FS-FS′ fold line for first fold

FD-FD′ fold line for second (double) fold

54 slitter bedroll

55 superposed webs

56 intermediate frame

P product width web

57 longitudinally folded product web

58 singlefold apparatus for 3-color mix

22′ duplicate folder-face-to-face

CDE cutoff units on dual folder

59 delivery belt pair

60 pair of superposed napkins

L1 length of product =repeat surface length

32 leading edge ports on anvil roll for L1

L2 length of segment L2

32′ leading edge ports on anvil roll for L2

L3 length of segment L3

32″ leading edge ports on anvil roll for L3

61 rotatable insert

62 hole in insert for path to roll conduit

S 1 slippage to alternate space—L1

S 2 slippage to alternate space—L2

S 3 slippage to alternate space—L3

V 3 restricted vacuum for slipping

L 1 segment length (example 12″)

63 reference line for phasing carrier to anvil

S12 slippage of L1 web (12′)

L 2 segment length (example 8″)

64 fold line for phasing to 12

S16 slippage for L2 web (8″)

65 phase angle for L 2 fold line

L3 segment length (example 6″)

66 fold line for phasing to L3

S 18 slippage for L3 web (6″)

67 phase angle for L3 fold line

FL1 folded segment on R 1 repeat

FL1′ folded segment on R 2 repeat

1 Apparatus for producing folded products simultaneously from a plurality of different colored webs or materials to form stacks of product having color or material sequences therein, comprising:
a pair of frames to support;
means to slit webs into product width webs,
means to longitudinally fold product webs,
a plurality of web feed metering roll pairs,
a plurality of web cutoff units each including a knife roll and an anvil roll for cutting separate streams of spaced segments and arranged to combine said separate streams of segments to form a continuous series of segments on successive repeats on the surface of a multi-repeat common carrier, wherein;
each if said metering rolls has a surface speed slower than the surface speed of a subsequent anvil roll to slideable retard said web for cutting and transfer to a spaced repeat surface of said anvil roll, for subsequent folding and transfer to a carrier roll,
said segments on spaced repeat surfaces of the anvil roll synchronized for placement on carrier repeat surfaces between segments from other of said cutoff plurality,
said anvil rolls having a plurality of repeat surfaces each including vacuum means to advance and uplift a front portion of said segment and overfolding said front portion coacting in cooperation with vacuumized ports on a carrier roll advancing at equal surface speed,
a carrier roll with at least one transverse line of vacuum ports between repeat surface ends to cooperatively fold and advance the combined series of segments, and,
means to remove the combined series of folded segments from said carrier.

2 The apparatus of claim 1 wherein the anvil and carrier rolls are made from solid blanks and have vacuum conduits defined by holes drilled parallel to the axis of roll rotation, the holes communicating with vacuum ports in the surface.

3 The apparatus of claim 1 wherein the ratio of repeat surfaces on the anvil roll and carrier roll is other than 1:1 and the surface speed of both rolls is equal.

4 The apparatus of claim 1 including means to advance and transfer a web to said anvil roll at a speed equal to the speed of the carrier surface divided by the plurality of cutoff units cooperating with a common carrier and said web is severed to produce a product length equal to the length of a repeat surface.

5 The apparatus of claim 1 wherin the distance between successive cutoff units is greater than one carrier repeat surface and the rotational phase relationship between anvil and carrier rolls is changed to place segments from an anvil roll within a carrier repeat surface.

6 The apparatus of claim 1 including a roll intermediate the anvil and carrier rolls, said intermediate roll having a transverse line of vacuum ports to complete a second cross fold in cooperation with the carrier roll.

7 The apparatus of claim 1 wherein two folders are arranged face-to-face and operate to deliver superposed single folded segment pairs contained between a set of delivery belts for subsequent packout.

8 The apparatus of claim 1 wherein the anvil roll has a plurality of vacuum ports along a plurality of transverse fold lines and the distance between a transverse line of ports and the cut trailing edge of a segment defines one selected length from a plurality of transverse fold lines and product lengths.

9 The apparatus of claim 8 wherein speed of the incoming web to the anvil roll is equal to the carrier surface speed divided by the number of cutoff units times the ratio of product length/length of a carrier repeat surface.

10 The apparatus of claim 1 wherein the anvil roll includes means for activating a vacuum conduit associated with a selected transverse line of vacuum ports.

11 The apparatus of claim 10 wherein said means for activating a selected vacuum conduit is a digitally controlled electronic device.

12 The apparatus of claim 1 wherein a web length of less than a repeat surface slips on a portion of the anvil roll surface before being cut.

13 The apparatus of claim 1 wherein selection of product length and folded length includes;
means for selecting a vacuum conduit,
means for electronically retarding the carrier relative to, and independent of, the anvil roll, motor means to separately drive the metering roll pair independently from the anvil roll-knife roll couple,
motor means to drive the anvil roll independently from the carrier, and,
motor means to drive the carrier in unison with each independently driven component, each at its selected speed

14 Folding apparatus for producing a selected length and means to make multiple product lengths on the same machine apparatus, comprising:
a pair of frames to suppport;
means to advance and longitudinally fold product width webs,
means to advance a product web at a selected speed, cut into segments and advance them on a series of consecutive repeat surfaces of an anvil roll wherein;
said metering rolls are separately driven by a variable speed digitally controlled motor, separately adjustable and for simultaneous operation with independent drives for anvil rolls and carrier roll.
said anvil roll includes vacuum ports along a plurality of transverse lines within each repeat surface of said anvil roll and means to activate a vacuum path to a selected line of said plurality.
means to separately drive said anvil/knife roll couple and means to cut said web advancing at a predetermined uniform speed for placement of a segment leading edge over the selected line of ports, advancement, and folding in cooperation with a carrier roll,
said carrier including vacuum ports along a transverse fold line within each repeat surface, and separate motor means for retarding the fold line ports to be operative at a pre-selected location for the cross fold,
means to rotate said carrier simultaneously with said anvil roll, and
means to remove said folded product from the carrier path.
